(19) United States
(12) Patent Application Publication
(10) Pub. No.: US 2010/0075600 A1
(43) Pub. Date: Mar. 25, 2010

(54) WIRELESS PICONETS, DEVICES AND METHODS THAT SELF-LEARN MULTI-FRAME SLOT PATTERNS

(75) Inventor: Jacobus Cornelis Haartsen, Hardenberg (NL)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/235,256

(22) Filed: Sep. 22, 2008

(51) Int. Cl. H04B 7/00; H04Q 7/24

(52) U.S. Cl. 455/41.2; 370/338

(57) ABSTRACT

A first device in a short-range wireless piconet self-learns a multi-frame piconet pattern that is used by a second device as a result of a deferral that reduces or avoids simultaneous transmission and reception by two transceivers at the second device. The first device uses this self-learned multi-frame piconet pattern to selectively control transmitting and receiving by the first device. Power can thereby be conserved at the first device. Related devices, networks and methods are described.

### BACKGROUND OF THE INVENTION

This invention relates to wireless networks and, more particularly, to short-range wireless piconets, devices and operating methods therefor.

Wireless piconets are widely used to allow short-range, ad-hoc wireless communications between adjacent devices. For example, Bluetooth is a well known short-range wireless piconet standard that can allow up to eight devices to be connected together in a short-range ad-hoc piconet. In particular, Bluetooth-enabled headsets are widely used to allow the headset to wirelessly communicate with a mobile telephone, an audio player, a computer, a Personal Digital Assistant (PDA), a vehicle navigation system or the like.

In a short-range wireless piconet, one device generally operates as a master device, and one or more devices operate as slave devices. For example, the Bluetooth headset may be a slave device, whereas the mobile telephone, audio player, computer, PDA, vehicle navigation system, etc., may be the master. Often, the master (or the slave) may include a wide area wireless network transceiver therein, as well. As used herein, “wide area” means larger transmitting/receiving area than a short-range, ad-hoc piconet. For example, the mobile telephone, audio player, computer, PDA, etc., may include a Wireless Local Area Network (WLAN), a Worldwide Interoperability for Microwave Access (WiMAX), a Long Term Evolution (LTE), a High Speed Packet Access (HSPA) and/or other wide area wireless network transceiver. Since the Bluetooth transceiver of the master (or the slave) and the wide area network transceiver are located in very close proximity in the master (or slave), i.e., collocated, they may interfere with each other even if they do not use the exact same frequency bands. More specifically, the isolation between the antennas is generally too low to guarantee undisturbed reception in one transceiver while the other transceiver is transmitting.

It is known to solve the collocation problem by applying time multiplexing, so that only one transceiver (wide area or piconet) can operate at any given time, as described in “Bluetooth/WiMAX Coexistence—Solution and Recommendations Based on Extended Synchronous Connection-Oriented Logical Link”, Bluetooth Special Interest Group, Draft, Revision D05r02, Nov. 19, 2007, hereinafter referred to as “Bluetooth D05r02”.

### SUMMARY OF THE INVENTION

Some embodiments allow a first device in a short-range wireless piconet to self-learn a multi-frame piconet pattern that is used by a second device as a result of a deferral that reduces or avoids simultaneous transmission and reception by two transceivers at the second device. The first device can use this self-learned multi-frame piconet pattern to selectively control transmitting and receiving by the first device. Power can thereby be conserved at the first device.

More specifically, some embodiments provide methods of operating a first device that communicates with a second device in a short-range wireless piconet. These methods include determining at the first device a multi-frame piconet pattern comprising at least two different piconet slot positions that are used by the second device to transmit to the first device in at least two different piconet frames and/or at least two different piconet slot positions that are used by the second device to receive from the first device in at least two different piconet frames. Transmitting and/or receiving by the first device is selectively controlled in response to the multi-frame piconet pattern that was determined by the first device so that the first device selectively transmits to the second device during the at least two different piconet slot positions in the at least two different piconet frames that were determined to be used by the second device to receive from the first device and/or the first device selectively receives from the second device during the at least two different piconet slot positions in the at least two different piconet frames that were determined to be used by the second device to transmit to the first device.

In some embodiments, the first device includes a first device transmitter and a first device receiver. Selectively controlling transmitting and/or receiving is performed by placing the first device transmitter in a sleep mode, except during the at least two different piconet slot positions in the at least two different piconet frames that were determined to be used by the second device to receive from the first device, and/or placing the first device receiver in a sleep mode, except during the at least two different piconet slot positions in the at least two different piconet frames that were determined to be used by the second device to transmit to the first device.

In other embodiments, the determining of the multi-frame piconet pattern at the first device is preceded by the second device selectively refraining from transmitting to the first device concurrent with receiving over a wide area wireless network, and/or the second device selectively refraining from receiving from the first device concurrent with transmitting over the wide area wireless network. Thus, the multi-frame piconet pattern may be produced as a result of the selective refraining from transmitting and/or from receiving by the second device that includes a collocated wide area wireless network transceiver. In some embodiments, the multi-frame piconet pattern is of a duration that is an integer multiple of a frame duration of the wide area wireless network. Moreover, in other embodiments, the short-range wireless piconet is a Bluetooth wireless piconet, and the wide area wireless network is a WLAN, WIMAX, LTE and/or HSPA wide area wireless network.

In still other embodiments, it may be determined at the second device that a first frame of the multi-frame piconet pattern is not usable to transmit to the first device and/or to receive from the first device while selectively refraining from transmitting to the first device concurrent with receiving over a wide area wireless network and/or selectively refraining from receiving from the first device concurrent with transmitting over the wide area wireless network. In some embodiments, if a first frame of the multi-frame piconet pattern is determined not to be usable, transmitting to the first device and/or receiving from the first device is performed at a higher bit density in a second frame of the multi-frame piconet pattern than in a third frame of the multi-frame piconet pattern. In other embodiments, transmitting to the first device and/or receiving from the first device is performed in adjacent slot positions that straddle adjacent frames in the multi-frame piconet pattern, in response to the determining. In still other embodiments, a bit density of transmitting and/or receiving in the multi-frame piconet pattern may be increased, in response to the determining. Accordingly, these embodiments may be used to at least partially compensate for the fact that a given frame of the multi-frame piconet pattern may not be usable due to wide area network coexistence.

Still other embodiments provide a first device that communicates with a second device in a short-range wireless piconet. The first device includes a multi-frame piconet pattern recognizer and a first device transceiver. The multi-frame piconet pattern recognizer is configured to determine a multi-frame piconet pattern comprising at least two different piconet slot positions that are used by the second device to transmit to the first device in at least two different piconet frames and/or at least two different piconet slot positions that are used by the second device to receive from the first device in at least two different piconet frames. The first device transceiver is configured to selectively transmit to the second device during the at least two piconet slot positions in the at least two different piconet frames that were determined by the pattern recognizer to be used by the second device to receive from the first device and/or to selectively receive from the first device during the at least two different piconet slot positions in the at least two different piconet frames that were determined by the pattern recognizer to be used by the second device to transmit to the first device.

In some embodiments, the first device includes a first device transmitter and a first device receiver. Selectively controlling transmitting and/or receiving is performed by placing the first device transmitter in a sleep mode, except during the at least two different piconet slot positions in the at least two different piconet frames that were determined to be used by the second device to receive from the first device, and/or placing the first device receiver in a sleep mode, except during the at least two different piconet slot positions in the at least two different piconet frames that were determined to be used by the second device to transmit to the first device.

In other embodiments, the determining of the multi-frame piconet pattern at the first device is preceded by the second device selectively refraining from transmitting to the first device concurrent with receiving over a wide area wireless network, and/or the second device selectively refraining from receiving from the first device concurrent with transmitting over the wide area wireless network. Thus, the multi-frame piconet pattern may be produced as a result of the selective refraining from transmitting and/or from receiving by the second device that includes a collocated wide area wireless network transceiver. In some embodiments, the multi-frame piconet pattern is of a duration that is an integer multiple of a frame duration of the wide area wireless network. Moreover, in other embodiments, the short-range wireless piconet is a Bluetooth wireless piconet, and the wide area wireless network is a WLAN, WiMAX, LTE and/or HSPA wide area wireless network.

In still other embodiments, it may be determined at the second device that a first frame of the multi-frame piconet pattern is not usable to transmit to the first device and/or to receive from the first device while selectively refraining from transmitting to the first device concurrent with receiving over a wide area wireless network and/or selectively refraining from receiving from the first device concurrent with transmitting over the wide area wireless network. In some embodiments, if a first frame of the multi-frame piconet pattern is determined not to be usable, transmitting to the first device and/or receiving from the first device is performed at a higher bit density in a second frame of the multi-frame piconet pattern than in a third frame of the multi-frame piconet pattern. In other embodiments, transmitting to the first device and/or receiving from the first device is performed in adjacent slot positions that straddle adjacent frames in the multi-frame piconet pattern, in response to the determining. In still other embodiments, a bit density of transmitting and/or receiving in the multi-frame piconet pattern may be increased, in response to the determining. Accordingly, these embodiments may be used to at least partially compensate for the fact that a given frame of the multi-frame piconet pattern may not be usable due to wide area network coexistence.

Still other embodiments provide a short-range wireless piconet comprising a second device and a first device. The second device comprises a wide area wireless transceiver and a second device transceiver that are collocated. The second device is configured to selectively refrain from transmitting to the first device over the second device transceiver concurrent with receiving from a wide area wireless network over the wide area wireless network transceiver and/or to selectively refrain from receiving from the first device over the second device transceiver concurrent with transmitting to the wide area wireless network over the wide area wireless network transceiver. The first device includes a first device transceiver. The first device is configured to determine a multi-frame piconet pattern comprising at least two different piconet slot positions that are used by the second device transceiver to transmit to the first device in at least two different piconet frames and/or at least two different piconet slots that are used by the second device transceiver to receive from the first device in at least two different piconet frames and to selectively control transmitting and/or receiving by the first device transceiver in response to the multi-frame piconet pattern that was determined by the first device so that the first device transceiver selectively transmits to the second device during the at least two different piconet slot positions in the at least two different piconet frames that were determined to be used by the second device to receive from the first device and/or the first device transceiver selectively receives from the second device during the at least two different piconet slot positions in the at least two different piconet frames that were determined to be used by the second device to transmit to the first device.

In some embodiments, the first device includes a first device transmitter and a first device receiver. Selectively controlling transmitting and/or receiving is performed by placing the first device transmitter in a sleep mode, except during the at least two different piconet slot positions in the at least two different piconet frames that were determined to be used by the second device to receive from the first device, and/or placing the first device receiver in a sleep mode, except during the at least two different piconet slot positions in the at least two different piconet frames that were determined to be used by the second device to transmit to the first device.

In other embodiments, the determining of the multi-frame piconet pattern at the first device is preceded by the second device selectively refraining from transmitting to the first device concurrent with receiving over a wide area wireless network, and/or the second device selectively refraining from receiving from the first device concurrent with transmitting over the wide area wireless network. Thus, the multi-frame piconet pattern may be produced as a result of the selective refraining from transmitting and/or from receiving by the second device that includes a collocated wide area wireless network transceiver. In some embodiments, the multi-frame piconet pattern is of a duration that is an integer multiple of a frame duration of the wide area wireless network. Moreover, in other embodiments, the short-range wireless piconet is a Bluetooth wireless piconet, and the wide area wireless network is a WLAN, WiMAX, LTE and/or HSPA wide area wireless network.

In still other embodiments, it may be determined at the second device that a first frame of the multi-frame piconet pattern is not usable to transmit to the first device and/or to receive from the first device while selectively refraining from transmitting to the first device concurrent with receiving over a wide area wireless network and/or selectively refraining from receiving from the first device concurrent with transmitting over the wide area wireless network. In some embodiments, if a first frame of the multi-frame piconet pattern is determined not to be usable, transmitting to the first device and/or receiving from the first device is performed at a higher bit density in a second frame of the multi-frame piconet pattern than in a third frame of the multi-frame piconet pattern. In other embodiments, transmitting to the first device and/or receiving from the first device is performed in adjacent slot positions that straddle adjacent frames in the multi-frame piconet pattern, in response to the determining. In still other embodiments, a bit density of transmitting and/or receiving in the multi-frame piconet pattern may be increased, in response to the determining. Accordingly, these embodiments may be used to at least partially compensate for the fact that a given frame of the multi-frame piconet pattern may not be usable due to wide area network coexistence.

Still other embodiments provide methods of operating a second device that communicates with a first device in a short-range wireless piconet. These methods include selectively refraining from transmitting to the first device concurrent with receiving over a wide area wireless network, and/or selectively refraining from receiving from the first device concurrent with transmitting over the wide area wireless network. A multi-frame piconet pattern is thereby produced that comprises at least two different piconet slot positions that are used by the second device to transmit to the first device in at least two different piconet frames and/or at least two different piconet slot positions that are used by the second device to receive from the first device in at least two different piconet frames.

In still other embodiments, it may be determined at the second device that a first frame of the multi-frame piconet pattern is not usable to transmit to the first device and/or to receive from the first device while selectively refraining from transmitting to the first device concurrent with receiving over a wide area wireless network and/or selectively refraining from receiving from the first device concurrent with transmitting over the wide area wireless network. In some embodiments, if a first frame of the multi-frame piconet pattern is determined not to be usable, transmitting to the first device and/or receiving from the first device is performed at a higher bit density in a second frame of the multi-frame piconet pattern than in a third frame of the multi-frame piconet pattern. In other embodiments, transmitting to the first device and/or receiving from the first device is performed in adjacent slot positions that straddle adjacent frames in the multi-frame piconet pattern, in response to the determining. In still other embodiments, a bit density of transmitting and/or receiving in the multi-frame piconet pattern may be increased, in response to the determining. Accordingly, these embodiments may be used to at least partially compensate for the fact that a given frame of the multi-frame piconet pattern may not be usable due to wide area network coexistence. In some embodiments, the multi-frame piconet pattern is of a duration that is an integer multiple of a frame duration of the wide area wireless network. Moreover, in other embodiments, the short-range wireless piconet is a Bluetooth wireless piconet, and the wide area wireless network is a WLAN, WiMAX, LTE and/or HSPA wide area wireless network.

Other systems, methods, and/or computer program products according to other embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram of a short-range wireless piconet and methods of operating same, according to various embodiments.

FIG. 2 is a flowchart of operations that may be performed by a dual-radio device, such as a dual-radio device of FIG. 1, according to various embodiments.

FIG. 3 is a flowchart of operations that may performed by a single radio device, such as a single radio device of FIG. 1, according to various embodiments.

FIG. 4 graphically illustrates timing diagrams of WiMAX and Bluetooth, and is a reproduction of FIG. 7-8 of Bluetooth D05r02.

FIG. 5 is a block diagram illustrating signaling between a Bluetooth radio and a collocated WLAN and/or WiMAX radio, and is a reproduction of FIG. 7-5 of Bluetooth D05r02.

FIG. 6 graphically illustrates Bluetooth master performance in a collocation situation according to various embodiments.

FIG. 7 graphically illustrates Bluetooth transactions at WiMAX TX-RX transition in frame m=4h+3, according to various embodiments.

FIG. 8 graphically illustrates timing diagrams of HSPA UL and Bluetooth, according to various embodiments.

### DETAILED DESCRIPTION

The present invention now will be described more fully hereinafter with reference to the accompanying figures, in which embodiments are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” (and variants thereof) when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” to another element/step (and variants thereof), it can be directly responsive to the other element/step, or intervening elements/steps may be present. In contrast, when an element/step is referred to as being “directly responsive” to another element/step (and variants thereof), there are no intervening elements/steps present. As used herein the term “and/or” includes any and all combinations of one or more of the associated listed items and may be abbreviated as “/”.

It will be understood that, although the terms first, second, third, etc. may be used herein to describe various elements, these elements should not be limited by these terms. These terms are only used to distinguish one element from another. Thus, for example, a first frame may be regarded as a second frame and vice versa, or a first device may be regarded as a second device and vice versa.

The present invention is described below with reference to block diagrams and/or flowchart illustrations of methods, apparatus (systems and/or devices) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, digital signal processor and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a processor of the computer and/or other programmable data processing apparatus to function in a particular manner, such that the instructions stored in the computer-readable memory produce an article of manufacture including instructions which implement the function/act as specified in the block diagrams and/or flowchart block or blocks.

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.) that runs on a processor such as a digital signal processor, collectively referred to as “circuitry” or “a circuit”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate or transport the program for use by or in connection with the instruction execution system, apparatus, or device.

The computer-usable or computer-readable medium may be, for example but not limited to, an electronic, magnetic, optical, electromagnetic or semiconductor system, apparatus or device. More specific examples (a non-exhaustive list) of the computer-readable medium would include the following: a portable computer diskette, a random access memory (RAM), a read-only memory (ROM), an erasable programmable read-only memory (EPROM or Flash memory), and a portable optical and/or magnetic media, such as a flash disk or CD-ROM.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated.

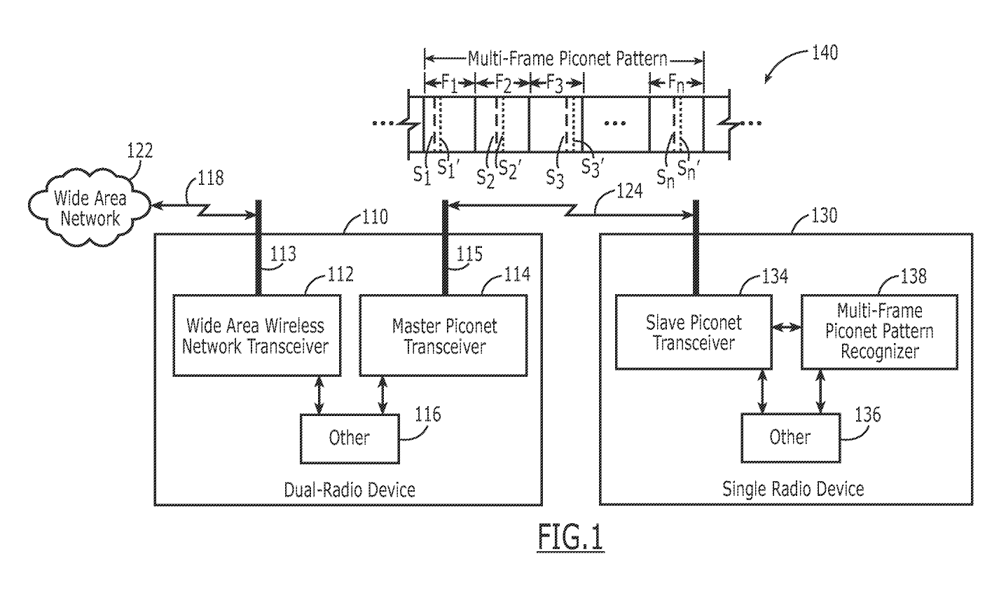

FIG. 1 is a block diagram of a wireless piconet and methods of operating same according to various embodiments. As shown in FIG. 1, the wireless piconet includes a dual-radio device 110 and a single radio device 130. The dual-radio device 110 includes a wide area wireless network transceiver 112, and a master piconet transceiver 114 that are collocated in the dual-radio device 110. The wide area wireless network transceiver 112 includes a wide area wireless network transmitter, a wide area wireless network receiver and a wide area wireless network antenna 113 that communicate with a wide area network 122 over a wireless link 118. The master piconet transceiver 114 includes a master piconet transmitter, a master piconet receiver and a master piconet antenna 115. It will be understood that various components may be shared between the wide area wireless network transceiver 112 and the master piconet transceiver 114 including the antennas 113 and 115 in some embodiments. In other embodiments, however, components are not shared as between the wide area wireless network transceiver 112 and the master piconet transceiver 114. In still other embodiments, the slave piconet transceiver 134 is collocated in the dual-radio device 110 and the master piconet transceiver 114 is located in the single radio device 130, as described in detail below.

Still referring to FIG. 1, other components/circuits 116 are also included in the dual-radio device 110. These other components/circuits may include a processor, controller, memory, user interface, and/or other components/circuits that provide the functionality of the dual-radio device 110, for example as a mobile telephone, audio player, computer, PDA, vehicle navigation system, etc. The design of a dual-radio device as described in this paragraph is known to those having skill in the art and need not be described further herein.

According to various embodiments, the dual-radio device 110 is configured to selectively refrain from transmitting to the single radio device 130 over the master piconet transceiver 114 using short-range, ad-hoc wireless piconet link 124, concurrent with receiving from a wide area wireless network 122 over the wide area wireless network transceiver 112 and link 118, and/or to selectively refrain from receiving from the single radio device 130 over the master piconet transceiver 114 and link 124 concurrent with transmitting to the wide area wireless network 122 over the wide area wireless network transceiver 112 and link 118. In particular, Bluetooth D05r02 proposed applying time multiplexing so that only one transceiver (wide area or piconet) can operate at any given time. However, various embodiments of the invention may arise from a recognition that this may be too strict a requirement, because the collocated transceivers 112/114 may transmit simultaneously, or may receive simultaneously, when they use two different frequency bands. The only potentially prohibited situation according to various embodiments is when one transceiver transmits and the other transceiver simultaneously receives. Accordingly, piconet and wide area network coexistence may be provided in the dual-radio device 110, by prohibiting concurrent transmission by one transceiver and reception by the other transceiver.

In order to avoid simultaneous transmission and reception by the two transceivers 112/114, sometimes one of the transceivers must defer its transmission or reception. A retransmission can take care of the eventual delivery. Usually, it is the piconet that defers operation, as the wide area wireless network transceiver may have little control over the on-the-air protocol and/or traffic allocation.

Still referring to FIG. 1, the single radio device 130 includes a slave piconet transceiver 134, a multi-frame piconet pattern recognizer 138 and other components 136. The other components may include a processor, memory, a user interface, such as a microphone and ear speaker and/or other components/circuits that provide the functionality of the single radio device 130, for example as a Bluetooth headset. The multi-frame piconet pattern recognizer 138 can be incorporated into one or more of the other components 136 or may be at least partially distinct therefrom.

The multi-frame piconet pattern recognizer 138 is configured to determine a multi-frame piconet pattern 140 in the wireless piconet link 124, comprising at least two different piconet slot positions S₁-Sₙ in at least two different piconet frames F₁-Fₙ that are used by the master piconet transceiver 114 to transmit to the slave piconet transceiver 134 and/or at least two different piconet slot positions S₁′-Sₙ′ that are used by the master piconet transceiver 114 to receive from the slave piconet transceiver 134 in at least two different piconet frames F₁-Fₙ. The single radio device 130 also includes a slave piconet transceiver 134 that is configured to selectively transmit to the dual-radio device 110 during the at least two piconet slot positions S₁′-Sₙ′ in the at least two different piconet frames F₁-Fₙ that were determined by the pattern recognizer 138 to be used by the dual-radio device 110 to receive from the single radio device 130, and/or to selectively receive from the dual-radio device 110 during the at least two piconet slot positions S₁-Sₙ in the at least two different piconet frames F₁-Fₙ that were determined by the pattern recognizer 138 to be used by the dual-radio device 110 to transmit to the single radio device 130.

Thus, the slave piconet transceiver 134 selectively transmits to the dual-radio device 110 over link 124 during those piconet slot positions that were determined to be used by the dual-radio device 110 to receive from the single radio device 130, and/or the slave piconet transceiver 134 selectively receives from the master transceiver 114 over link 124 during those piconet slot positions that were determined to be used by the master piconet transceiver 114 to transmit to the slave piconet transceiver 134. Accordingly, the multi-frame piconet pattern recognizer 138 self-learns the multi-frame piconet pattern 140 that is used by the master piconet transceiver 114 to selectively refrain from simultaneous transmission by one of the wide area network transceiver 112 or the master piconet transceiver 114 and reception by the other of the master piconet transceiver 114 and the wide area wireless network transceiver 112.

In some embodiments, the slave piconet transmitter may be placed in a lower-power or powered-off sleep mode, except during those piconet slot positions frames S₁′-Sₙ′ that were determined to be used by the dual-radio device 110 to receive from the single radio device 130, and/or the slave piconet receiver may be placed in a sleep mode, except during those piconet slot positions S₁-Sₙ that were determined to be used by the dual-radio device 110 to transmit to the single radio device 130. Power can thereby be conserved by adapting the sleep mode of the slave piconet transceiver 134 based on the multi-frame piconet pattern 140 that is learned by the multi-frame piconet pattern recognizer 138. This power saving may be particularly beneficial in a piconet slave unit, such as a Bluetooth earpiece, where battery power may be quite precious.

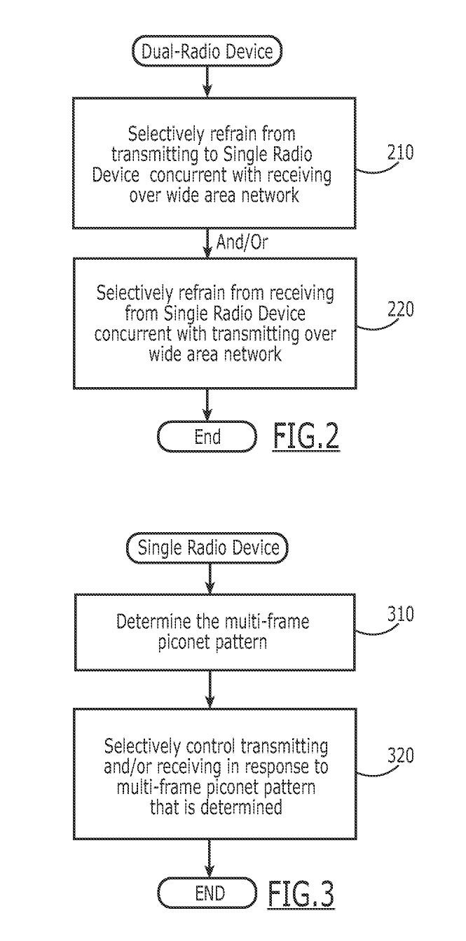

FIG. 2 is a flowchart of operations that may be performed by a dual-radio device, such as a dual-radio device 110 of FIG. 1, according to various embodiments of the present invention. These operations may be performed by the wide area network transceiver 112, the master piconet transceiver 114 and the other components 116 including a controller, according to various embodiments.

Referring to FIG. 2 at Block 210, the dual-radio device, e.g., the master piconet transceiver 114, selectively refrains from transmitting to the single radio device 130, e.g., the slave piconet transceiver 134 over link 124, concurrent with receiving over a wide area wireless network 122, for example using the wide area wireless network transceiver 112 and link 118. Also, at Block 220, the dual-radio device 110 selectively refrains from receiving from the single radio device 130, e.g., from the slave unit piconet transceiver 134 over link 124, concurrent with transmitting, e.g., by the wide area wireless network transceiver 112, over the wide area wireless network 122 and link 118. The operations of Blocks 210 and 220, therefore, create a multi-frame piconet pattern in link 124, for example the multi-frame piconet pattern 140 of FIG. 1, wherein at least two different piconet slot positions are used by the dual-radio device 110 to transmit to the single radio device 130 in at least two different piconet frames, and/or at least two different piconet slot positions are used by the dual-radio device 110 to receive from the single radio device 130 in at least two different piconet frames. It will be understood that either or both operations of Blocks 210 and 220 may be performed in various embodiments, so that “and/or” is indicated between Blocks 210 and 220.

Additional embodiments of Blocks 210/220 will now be described. In particular, in some embodiments, the dual-radio device 110 may also determine that a first frame of the multi-frame piconet pattern 140, such as frame F₁, is not usable to transmit to the single radio device 130 or to receive from the single radio device 130 at all, in order to selectively refrain from transmitting to the single radio device 130 concurrent with receiving over a wide area wireless network 122 and/or to selectively refrain from receiving from the single radio device 130 concurrent with transmitting over the wide area wireless network 122. In other words, a given frame may not be usable at all while reducing/avoiding interference with a collocated wide area network transceiver 112. In these embodiments, actions may be taken by the dual-radio device 110 to increase the data capacity of at least one of the remaining frames in the multi-frame piconet pattern 140, so as to reduce or avoid the loss of capacity by virtue of the fact that the first frame is not usable to transmit and/or to receive.

In particular, in some embodiments, data capacity may be increased by transmitting to the single radio device 130 and receiving from the single radio device 130 at a higher bit density in a second frame, such as frame F₂ of a multi-frame piconet pattern 140, than in a third frame, such as frame F₃ of the multi-frame piconet pattern. Accordingly, bit density may be increased in at least one frame. In other embodiments, the dual-radio device 110 may transmit to the single radio device 130 and receive from the single radio device 130 in adjacent slot positions that straddle adjacent frames in the multi-frame piconet pattern. For example, transmitting and receiving may straddle a last slot of last frame Fₙ and a first slot of frame F₁ of the succeeding pattern 140. Finally, in still other embodiments, a bit density of transmitting and receiving in the multi-frame piconet pattern may be increased. Thus, these embodiments can at least partially compensate for the fact that a given frame of the multi-frame piconet pattern 140 may be unusable due to wide area network transceiver coexistence.

FIG. 3 is a flowchart of operations that may be performed by a single radio device, such as a single radio device 130 of FIG. 1, according to various embodiments. In particular, at Block 310, the single radio device determines a multi-frame piconet pattern, such as the multi-frame piconet pattern 140 of FIG. 1, that comprises at least two different piconet slot positions S₁ . . . Sₙ that are used by the dual-radio device 110 to transmit to the single radio device 130 in at least two different piconet frames F₁-Fₙ and/or at least two different piconet slot positions S₁′-S,ₙ′ that are used by the dual-radio device 110 to receive from the single radio device 130 in at least two different piconet frames F₁-Fₙ. Operations at Block 310 may be performed by the multi-frame piconet pattern recognizer 138 of FIG. 1. Then, as shown at Block 320, transmitting and/or receiving by the single radio device 130 is selectively controlled in response to the multi-frame piconet pattern 140 that was determined by the single radio device 130, so that the single radio device 130 selectively transmits to the dual-radio device 110 during those piconet slot positions S₁′-Sₙ′ that were determined to be used by the dual-radio device 110 to receive from the single radio device 130, and/or the single radio device 130 selectively receives from the dual-radio device 110 during those piconet slot positions S₁-Sₙ that were determined to be used by the dual-radio device 110 to transmit to the single radio device 130. As was noted above, operations of Block 320 may be used to selectively place the slave transmitter in a sleep mode and/or to selectively place the slave receiver in a sleep mode.

Additional discussion of various embodiments will now be provided. In particular, as was described above, multiple radio systems (e.g., transceivers 112 and 114) may be collocated in a single device (e.g., device 110) like a phone or a laptop. Both transceivers (also referred to as “radios”) may carry traffic with Quality of Service (QoS) requirements. As an example, a cellular connection may carry a Voice over IP (VoIP) link, and may simultaneously carry a short-range connection to a wireless headset. Examples are found with WLAN/Bluetooth, WiMAX/Bluetooth, LTE/Bluetooth, and HSPA/Bluetooth. WiMAX/Bluetooth will now be used as an illustrative example.

Since the radios (e.g., 112 and 114) are located in very close proximity, they may interfere with each other, even if they do not use the exact same frequency bands. The isolation between the antennas (e.g., 113 and 115) is generally too low to guarantee undisturbed reception in one radio when the other radio is transmitting.

The collocation problem may be solved as noted in Bluetooth D05r02 by applying time multiplexing: only one radio can operate at one moment in time. However, various embodiments of the invention may rise from recognition that this generally is too strict a requirement, because when the radios make use of different frequency bands, they may transmit simultaneously, or receive simultaneously without excessive interference.

To avoid simultaneous transmitting (TX) and receiving (RX), sometimes one of the radios must defer its transmission or reception. A retransmission can take care of the eventual delivery. Usually, it is the Bluetooth device that defers operation, as the WiMAX client has little influence on the air protocol and/or the traffic allocations. Thus, according to various embodiments, when the collocated Bluetooth radio is a master (as it often is), it can allocate the proper time slots in order to avoid collisions with the WiMAX operations. Some embodiments arise from the additional recognition that this procedure may result in excessive power consumption in the single radio (e.g., Bluetooth slave) device. In particular, if the master transmissions do not arrive at the proper time, the slave device may need to extend the active window to listen for additional, deferred, transmissions.

The Bluetooth voice protocol is based on a 3.75 ms interval (frame). Cellular voice protocols are based on 5, 10, or 20 ms intervals (frames). The relative timing between the cellular and Bluetooth radios determines at which time instances the Bluetooth radio needs to defer its operation to avoid collisions. This time may change per frame. However, there is a distinct multi-frame pattern because of the repetitive nature in both the cellular link and the Bluetooth link. Therefore, although the Bluetooth slave has no prior knowledge when the deferral takes place, it can learn the repetitive multi-frame pattern and adapt its activity to this pattern. This can reduce or prevent excessive listening and wasteful transmissions by the slave and thus preserve power in the slave device.

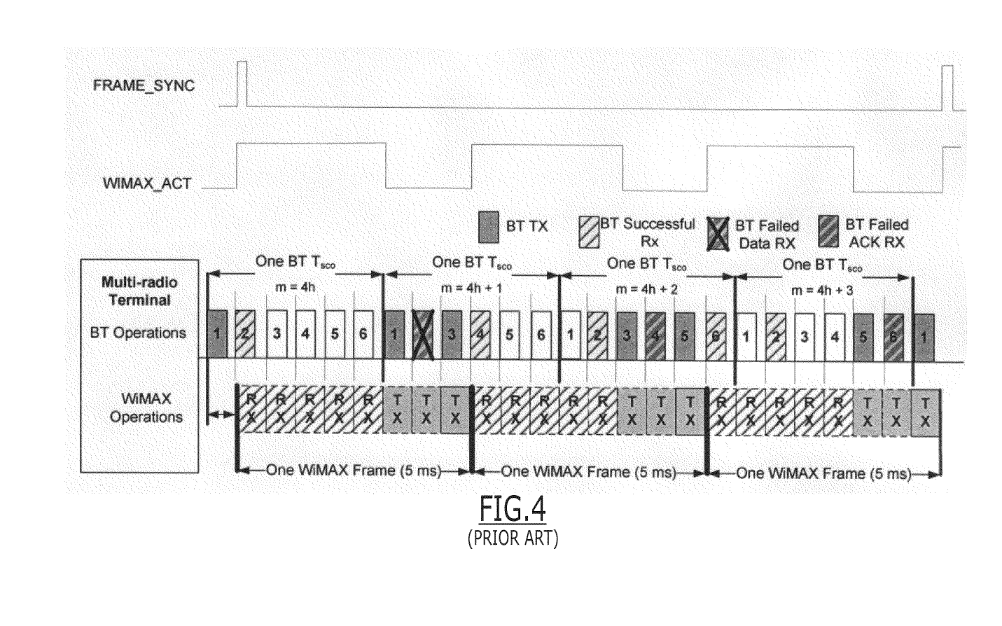

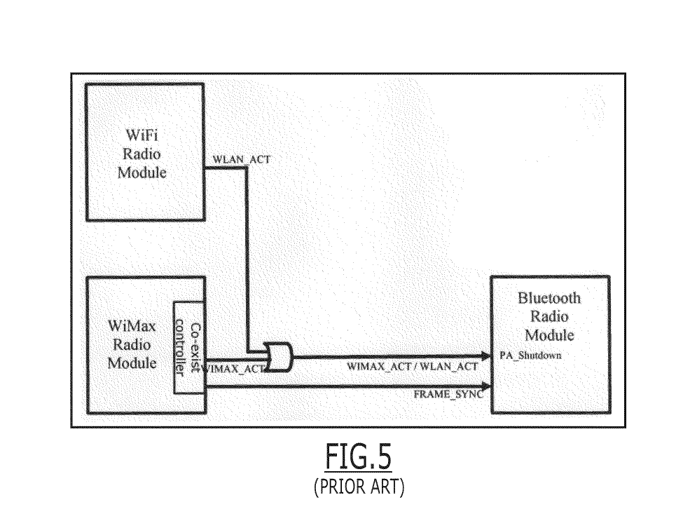

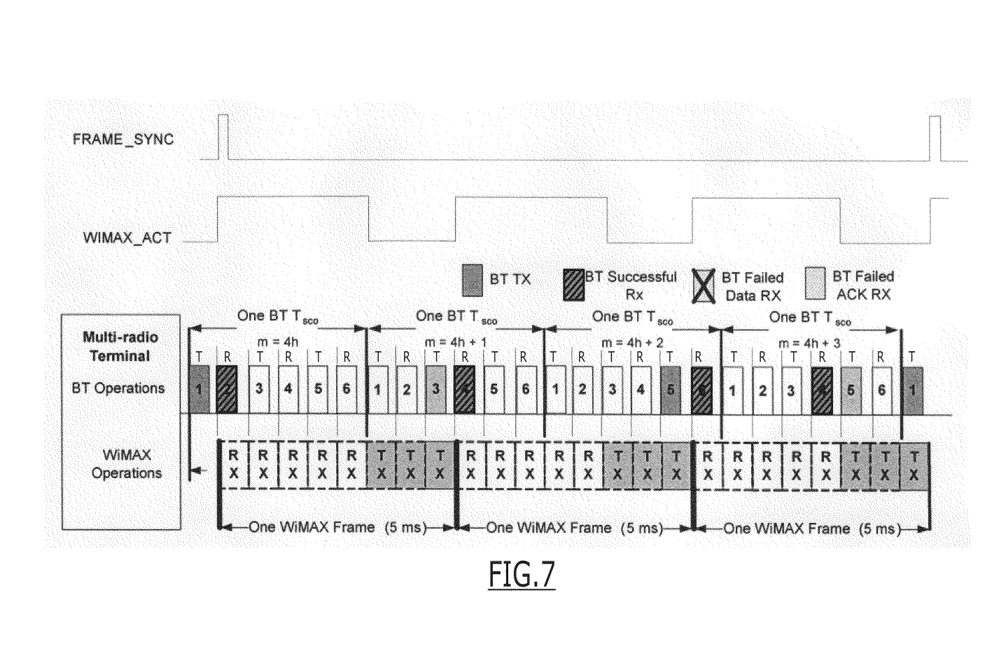

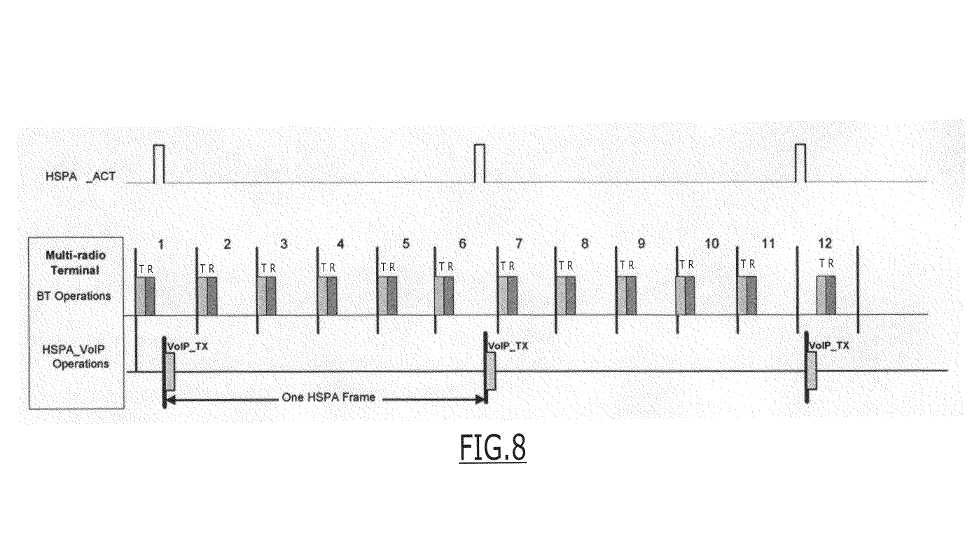

The basic problem may be explained with an example. In FIG. 4, which is a reproduction of FIG. 7-8 of Bluetooth D05r02, assume a dual-radio device (also referred to as a “Multi-radio Terminal”), such as a dual-radio device 110, contains a WiMAX radio, such as a wide-area transceiver 112, and Bluetooth radio, such as a piconet transceiver 114. The WiMAX is a TDD version with a downlink-to-uplink (DL:UL) ratio (arbitrarily chosen) of 5:3. The Bluetooth applies an Extended Synchronous Connection Oriented (eSCO) voice connection using Ev3 packets and with 2 possible retransmissions. Frame sync and WiMAX_ACT are signals from the WiMAX radio to the Bluetooth radio as proposed by Bluetooth D05r02 FIG. 7-5, and reproduced in FIG. 5. In particular, the signal WiMAX_ACT indicates when the WiMAX radio is receiving. In that mode (WiMAX_ACT is high), the Bluetooth radio is not permitted to transmit. This is illustrated in FIG. 4. Furthermore, any signals received by the Bluetooth receiver while the WiMAX radio is transmitting (WiMAX_ACT is low) may be lost.

FIG. 4 also shows that it is possible to sustain a voice link with Bluetooth even if collisions with the WiMAX radio occur. In the example of FIG. 4, the Bluetooth master may carry out a rather inefficient process. For example, in frame m=4h+1, it sends on slot 1 although it (maybe) knows that no acknowledgement can be received. So it could better skip slot 1 and transmit in slot 3 only. Similarly in frame m=4h+2, it does not need to receive in slot 2 since nothing was transmitted in slot 1. Furthermore, transmission in slot 3 is not necessary as no ACK can be received in slot 4. In frame m=4h+3, there does not exist any transmit opportunity. So there is no need to receive either.

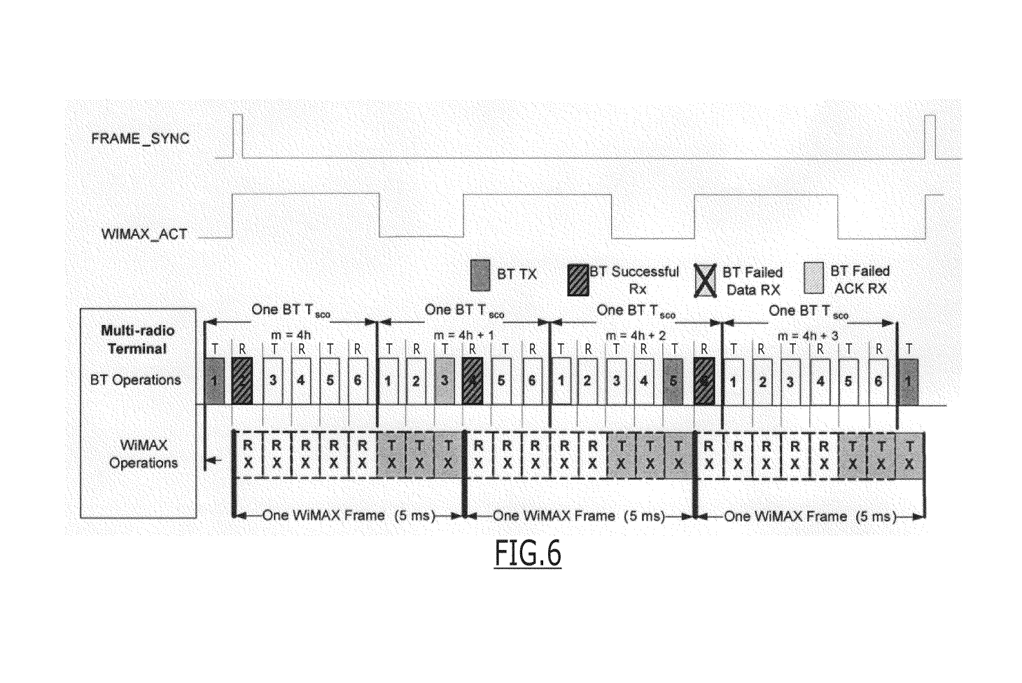

A more efficient scheduling for the multi-radio device, according to various embodiments, is shown in FIG. 6. To apply this scheduling, the multi-radio device either receives the WiMAX_ACT duration from the WiMAX module (the timing it can derive from the WiMAC_ACT signal directly), or it can on the fly “learn” the duration by examining the WiMAX_ACT signal. The “deferral” pattern of the multi-radio device is 0, 2, 4, ∞, 0, 2, 4, ∞, 0, . . . in the series of frames, relative to the first slot of the frame.

Consider now what can happen at the single radio device 130. In a conventional case, the single radio device expects a voice packet in the first slot of the frame. It then returns a voice packet with an ACK. If no voice packet is received, it will anyway send a voice packet but also a NAK since no previous voice packet was received. In addition, it keeps listening for a voice packet from the dual-radio device 110. This means, that in the example of FIG. 4, the single radio device can sleep for most of the time in frame m=4h (2 out of 6 slots are active), but in all remaining frames, it needs to be awake much more (4 out of 6 slots in frame m=4h+1, and all 6 slots in frames m=4h+2 and m=4h+3.

A more efficient, power-savings scheme for the single radio device may result when it “learns” the (successful) transmissions from the dual-radio device as shown in FIG. 6, according to various embodiments. In that case, for frame m=4h+1, it is only active during slots 3 and 4. For frame m=4h+2, this will be slots 5 and 6. This can reduce the power consumption in the single radio device considerably. The deferral pattern applied by the dual-radio device is repetitive (4 frames in this case since 4×3.75 ms=3×5 ms). In other words, in some embodiments, the multi-frame piconet pattern is an integer multiple of frame duration of the wide area wireless network. Thus, the single radio device can quickly learn the pattern applied by the dual-radio device and adapts its own scheduling.

An issue may remain with frame m=4h+3. As shown, a there is no Bluetooth voice exchange possible. However, as shown in FIG. 6, the successful Bluetooth exchange happens at the WiMAX TX-RX transition (i.e., adjacent slot positions that straddle adjacent frames in the multi-frame piconet pattern). In the case of frame m=4h+3, those transitions lie outside the Bluetooth frame. There are a number of ways to solve this problem, according to various embodiments. In some embodiments, the voice packet that should be sent in frame m=4h+3, is sent in frame m=4h+4 (or another frame) instead, together with the voice packet that should be sent in m=4h+4. This may use a different packet type that can contain more bits in the payload (like an extended voice (EV) EV4 or 2-EV3 packet), but only for frame m=4h+4. The other frames may keep the EV3 packet type. Thus, a higher bit density may be used in one or more other frames. Alternatively, a packet exchange is done on the WiMAX RX-TX transition for frame m=4h+3. This is illustrated in FIG. 7. Note that in this case, the reception in the dual-radio device precedes the transmission in the dual-radio device. Thus, adjacent slot positions that straddle adjacent frames in the multi-frame piconet pattern are used. Finally, in still other embodiments, a different Bluetooth interval with corresponding packet type may be chosen. For example, a packet type 2-EV3 is used, which can contain twice as many bits as EV3. The eSCO interval may, thus, be increased from 3.75 ms to 7.5 ms. In that case, the Bluetooth transactions will take place in frame m=4h, slots 1 and 2, and in frame m=4h+2, slots 5 and 6. Thus, bit density may be increased. In still other embodiments, the single radio device 130 may simply sleep during the entire m=4h+3 frame.

Note that the Multi-frame pattern recognizer 138 can learn the successful transmission and reception based on the (re-)transmission behavior, the response behavior, and/or the error patterns while the single-radio device 130 communicates with the dual-radio device 110.

In the description above, it was assumed that the piconet transceiver 114 which is collocated with a wide area wireless transceiver 112 in dual-radio device 110, is a master device in the short-range communication link 124. In that case, the wide area transceiver 112 will control the master piconet transceiver 114 to align transmissions and receptions of both radios. The slave piconet transceiver 134 will learn this adapted pattern as described above. However, it is also possible that the piconet transceiver 114 in dual-radio device 110 is a slave device and the piconet transceiver 134 in single radio device 130 is a master. In that case, the wide area wireless transceiver 112 will control the collocated slave piconet transceiver to prevent collisions. But based on the error behavior and successful responses from the collocated slave piconet transceiver, the master piconet transceiver in the single radio device can learn the enforced multi-frame pattern as well. That is, after learning the pattern, it will only transmit when the wide area transceiver 112 is not transmitting, and only receive when the wide area transceiver 112 is not receiving. Again, large power savings can be achieved when the single radio device can be asleep at times it cannot communicate with the dual-radio device. In view of the above, the two short-range wireless piconet devices that communicate with one another may be generally referred to as first and second devices, with the master and slave locations being interchangeable.

Systems different from WiMAX may use other frame lengths. A typical frame length for VoIP is 20 ms. Depending on the eSCO interval, this results in a different repetitive deferral pattern applied by the dual-radio device 110, which can be learned by the single radio device 130. Since the deferral process is based on scheduling of the dual-radio device 110, no changes in the Bluetooth specification are needed.

Furthermore, various embodiments are not restricted to Bluetooth. Different radios that support QoS links with intervals that are not integer multiples of each other, will show a repetitive “collision” behavior which can be solved by repetitive deferral patterns applied by the collocated radios. These patterns can be learned by the units that communicate with these collocated radios to reduce or minimize the duty cycle.

Another example is UMTS (or LTE) in the extension band at 2.5 GHz. The ITU has selected the band 2500-2570 MHz for FDD uplink. If VoIP is applied on an HSPA link, the Bluetooth radio will be blocked from reception for a few ms every 20 ms (i.e., the VoIP interval). The HSPA FDD downlink will be at the band 2620-2690 MHz. With proper filtering, the Bluetooth transmissions can be suppressed in the UMTS receiver. So there may be no restrictions on the Bluetooth TX. A possible timing diagram for Bluetooth/HSPA_VoIP collocation is shown in FIG. 8 (note the different time scale). The Bluetooth deferral pattern is repetitive with an interval of 16 frames or 60 ms (16×3.75 ms=3×20 ms). For this particular case (initial offset between Bluetooth and HSPA, the deferral is only in frame 12. The slave can quickly “learn” that in frame m=16h+12, it is active in slots 3 and 4 rather than slots 1 and 2.

Accordingly, some embodiments have recognized that WiMAX, LTE and/or HSPA (at 2.5 GHz) and Bluetooth (at 2.4 GHz) that are collocated in the same device, may interfere due to the close proximity of the radio antennas. An extra challenge may occur when both radios carry QoS traffic, for example, when a terminal relays VoIP to a wireless headset. According to some embodiments, the Bluetooth master can adapt its timing to avoid collisions in time, and the Bluetooth slave can self-learn the repetitive behavior of the timing and will adapt to potentially save power.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method of operating a first device that communicates with a second device in a short-range wireless piconet comprising:
determining at the first device a multi-frame piconet pattern comprising at least two different piconet slot positions that are used by the second device to transmit to the first device in at least two different piconet frames and/or at least two different piconet slot positions that are used by the second device to receive from the first device in at least two different piconet frames; and
selectively controlling transmitting and/or receiving by the first device in response to the multi-frame piconet pattern that was determined by the first device so that the first device selectively transmits to the second device during the at least two different piconet slot positions in the at least two different piconet frames that were determined to be used by the second device to receive from the first device and/or the first device selectively receives from the second device during the at least two different piconet slot positions in the at least two different piconet frames that were determined to be used by the second device to transmit to the first device.

2. A method according to claim 1 wherein determining at the first device is preceded by the following that is performed at the second device:
selectively refraining from transmitting to the first device concurrent with receiving over a wide area wireless network; and/or
selectively refraining from receiving from the first device concurrent with transmitting over the wide area wireless network.

3. A method according to claim 1 wherein the first device includes a first device transmitter and a first device receiver and wherein selectively controlling transmitting and/or receiving comprises placing the first device transmitter in a sleep mode except during the at least two different piconet slot positions in the at least two different piconet frames that were determined to be used by the second device to receive from the first device and/or placing the first device receiver in a sleep mode except during the at least two different piconet slot positions in the at least two different piconet frames that were determined to be used by the second device to transmit to the first device.

4. A method according to claim 2 further comprising determining at the second device that a first frame of the multi-frame piconet pattern is not usable to transmit to the first device and/or to receive from the first device while selectively refraining from transmitting to the first device concurrent with receiving over the wide area wireless network and/or selectively refraining from receiving from the first device concurrent with transmitting over the wide area wireless network, the method further comprising transmitting to the first device and/or receiving from the first device at a higher bit density in a second frame of the multi-frame piconet pattern than in a third frame of the multi-frame piconet pattern, in response to the determining.

5. A method according to claim 2 further comprising determining at the second device that a first frame of the multi-frame piconet pattern is not usable to transmit to the first device and/or to receive from the first device while selectively refraining from transmitting to the first device concurrent with receiving over the wide area wireless network and/or selectively refraining from receiving from the first device concurrent with transmitting over the wide area wireless network, the method further comprising transmitting to the first device and/or receiving from the first device in adjacent slot positions that straddle adjacent frames in the multi-frame piconet pattern, in response to the determining.

6. A method according to claim 2 further comprising determining at the second device that a first frame of the multi-frame piconet pattern is not usable to transmit to the first device and/or to receive from the first device while selectively refraining from transmitting to the first device concurrent with receiving over the wide area wireless network and/or selectively refraining from receiving from the first device concurrent with transmitting over the wide area wireless network, the method further comprising increasing a bit density of transmitting and/or receiving in the multi-frame piconet pattern, in response to the determining.

7. A method according to claim 2 wherein the multi-frame piconet pattern is of a duration that is an integer multiple of a frame duration of the wide area wireless network.

8. A method according to claim 2 wherein the short-range wireless piconet is a Bluetooth wireless piconet and wherein the wide area wireless network is a WLAN, WiMAX, LTE and/or HSPA wide area wireless network.

9. A first device that communicates with a second device in a short-range wireless piconet, the first device comprising:
a multi-frame piconet pattern recognizer that is configured to determine a multi-frame piconet pattern comprising at least two different piconet slot positions that are used by the second device to transmit to the first device in at least two different piconet frames and/or at least two different piconet slot positions that are used by the second device to receive from the first device in at least two different piconet frames; and
a first device transceiver that is configured to selectively transmit to the second device during the at least two different piconet slot positions in the at least two different piconet frames that were determined by the pattern recognizer to be used by the second device to receive from the first device and/or to selectively receive from the second device during the at least two different piconet slot positions in the at least two different piconet frames that were determined by the pattern recognizer to be used by the second device to transmit to the first device.

10. A first device according to claim 9 wherein the first device transceiver includes a first device transmitter and a first device receiver and wherein the first device transceiver is further configured to place the first device transmitter in a sleep mode except during the at least two different piconet slot positions in the at least two different piconet frames that were determined by the pattern recognizer to be used by the second device to receive from the first device and/or to place the first device receiver in a sleep mode except during the at least two different piconet slot positions in the at least two different piconet frames that were determined by the pattern recognizer to be used by the second device to transmit to the first device.

11. A first device according to claim 10 wherein the multi-frame piconet pattern is of a duration that is an integer multiple of a frame duration of a wide area wireless network transceiver that is collocated in the second device.

12. A first device according to claim 11 wherein the short-range wireless piconet is a Bluetooth wireless piconet and wherein the wide area wireless network is a WLAN, WiMAX, LTE and/or HSPA wide area wireless network.

13. A method of operating a second device that communicates with a first device in a short-range wireless piconet comprising:
selectively refraining from transmitting to the first device concurrent with receiving over a wide area wireless network; and/or
selectively refraining from receiving from the first device concurrent with transmitting over the wide area wireless network to thereby produce a multi-frame piconet pattern comprising at least two different piconet slot positions that are used by the second device to transmit to the first device in at least two different piconet frames and/or at least two different piconet slot positions that are used by the second device to receive from the first device in at least two different piconet frames.

14. A method according to claim 13 further comprising determining at the second device that a first frame of the multi-frame piconet pattern is not usable to transmit to the first device and/or to receive from the first device while selectively refraining from transmitting to the first device concurrent with receiving over the wide area wireless network and/or selectively refraining from receiving from the first device concurrent with transmitting over the wide area wireless network, the method further comprising transmitting to the first device and/or receiving from the first device at a higher bit density in a second frame of the multi-frame piconet pattern than in a third frame of the multi-frame piconet pattern, in response to the determining.

15. A method according to claim 13 further comprising determining at the second device that a first frame of the multi-frame piconet pattern is not usable to transmit to the first device and/or to receive from the first device while selectively refraining from transmitting to the first device concurrent with receiving over the wide area wireless network and/or selectively refraining from receiving from the first device concurrent with transmitting over the wide area wireless network, the method further comprising transmitting to the first device and/or receiving from the first device in adjacent slot positions that straddle adjacent frames in the multi-frame piconet pattern, in response to the determining.

16. A method according to claim 13 further comprising determining at the second device that a first frame of the multi-frame piconet pattern is not usable to transmit to the first device and/or to receive from the first device while selectively refraining from transmitting to the first device concurrent with receiving over the wide area wireless network and/or selectively refraining from receiving from the first device concurrent with transmitting over the wide area wireless network, the method further comprising increasing a bit density of transmitting and/or receiving in the multi-frame piconet pattern, in response to the determining.

17. A method according to claim 13 wherein the multi-frame piconet pattern is of a duration that is an integer multiple of a frame duration of the wide area wireless network.

18. A method according to claim 13 wherein the short-range wireless piconet is a Bluetooth wireless piconet and wherein the wide area wireless network is a WLAN, WiMAX, LTE and/or HSPA wide area wireless network.

19. A second device that communicates with a first device in a wireless piconet according to the method of claim 13.

20. A second device that communicates with a first device in a wireless piconet according to the method of claim 14.
